(19) United States
(12) Patent Application Publication
(10) Pub. No.: US 2026/0119671 A1
(43) Pub. Date: Apr. 30, 2026

(54) BACKPROPAGATION AND MONTE CARLO TREES FOR SOFTWARE VULNERABILITY ANALYSIS

(71) Applicant: International Business Machines Corporation, Armonk, NY (US)

(72) Inventors: Yu Zui You, Ningbo (CN); Deng Xin Luo, XIAN (CN); Rui Han, XIAN (CN); Jun Guo, XIAN (CN); Sen Liang, XIAN (CN); Yi Ming Wang, XIAN (CN); Mu Dan Cao, Beijing (CN)

(21) Appl. No.: 18/926,274

(22) Filed: Oct. 24, 2024

(51) Int. Cl. G06F 21/57; G06F 21/54

(52) U.S. Cl. CPC G06F 21/577; G06F 21/54

(57) ABSTRACT

A Monte Carlo tree structure of related software packages for a software project is constructed, wherein one or more vulnerable nodes of the Monte Carlo tree structure indicate a software vulnerability. A Monte Carlo tree search algorithm is applied on the Monte Carlo tree structure, the applying comprising expanding the Monte Carlo tree structure with multiple respective candidate nodes corresponding to alternative software packages for replacement of the one or more vulnerable nodes and performing iterative simulation and backpropagation through different tree updates using the multiple respective candidate nodes to identify at least one best replacement node from the multiple candidate nodes. A repaired software set for the software project is exported, the repaired software set including additional software corresponding to the at least one identified best replacement node, the additional software replacing one or more software packages that are related to the one or more vulnerable nodes.

### BACKGROUND

The present invention relates generally to the electrical, electronic and computer arts and, more particularly, to machine learning and computer-aided software design.

A variety of software component analysis (SCA) tools exist on the market today to support developer testing and debugging by identifying interdependencies between software components, providing repair suggestions, and the like. In the project deployment phase, however, conventional SCA tools can only capture the direct dependencies of a single package, rather than infer indirect dependencies from available information to restore the dependency tree of the entire project. Thus, existing SCA tools still face many challenges in identifying security issues quickly and accurately.

### BRIEF SUMMARY

Principles of the invention provide systems and techniques for automatic detection and mitigation of security vulnerabilities via backpropagation of deep neural networks based on Monte Carlo trees. In one aspect, an exemplary method includes the operations of constructing a Monte Carlo tree structure of related software packages for a software project, wherein one or more vulnerable nodes of the Monte Carlo tree structure indicate a software vulnerability; applying a Monte Carlo tree search algorithm on the Monte Carlo tree structure, the applying comprising expanding the Monte Carlo tree structure with multiple respective candidate nodes corresponding to alternative software packages for replacement of the one or more vulnerable nodes; and performing iterative simulation and backpropagation through different tree updates using the multiple respective candidate nodes to identify at least one best replacement node from the multiple candidate nodes; and exporting a repaired software set for the software project, the repaired software set including additional software corresponding to the at least one identified best replacement node, the additional software replacing one or more software packages that are related to the one or more vulnerable nodes.

In one aspect, a computer program product comprises one or more tangible computer-readable storage media and program instructions stored on at least one of the one or more tangible computer-readable storage media, the program instructions executable by a processor, the program instructions comprising constructing a Monte Carlo tree structure of related software packages for a software project, wherein one or more vulnerable nodes of the Monte Carlo tree structure indicate a software vulnerability; applying a Monte Carlo tree search algorithm on the Monte Carlo tree structure, the applying comprising expanding the Monte Carlo tree structure with multiple respective candidate nodes corresponding to alternative software packages for replacement of the one or more vulnerable nodes; and performing iterative simulation and backpropagation through different tree updates using the multiple respective candidate nodes to identify at least one best replacement node from the multiple candidate nodes; and exporting a repaired software set for the software project, the repaired software set including additional software corresponding to the at least one identified best replacement node, the additional software replacing one or more software packages that are related to the one or more vulnerable nodes.

In one aspect, a system comprises a memory and at least one processor, coupled to the memory, and operative to perform operations comprising constructing a Monte Carlo tree structure of related software packages for a software project, wherein one or more vulnerable nodes of the Monte Carlo tree structure indicate a software vulnerability; applying a Monte Carlo tree search algorithm on the Monte Carlo tree structure, the applying comprising expanding the Monte Carlo tree structure with multiple respective candidate nodes corresponding to alternative software packages for replacement of the one or more vulnerable nodes; and performing iterative simulation and backpropagation through different tree updates using the multiple respective candidate nodes to identify at least one best replacement node from the multiple candidate nodes; and exporting a repaired software set for the software project, the repaired software set including additional software corresponding to the at least one identified best replacement node, the additional software replacing one or more software packages that are related to the one or more vulnerable nodes.

As used herein, “facilitating” an action includes performing the action, making the action easier, helping to carry the action out, or causing the action to be performed. Thus, by way of example and not limitation, instructions executing on a processor might facilitate an action carried out by instructions executing on a remote processor, by sending appropriate data or commands to cause or aid the action to be performed. Where an actor facilitates an action, other than by performing the action, the action is nevertheless performed by some entity or combination of entities.

Techniques as disclosed herein can provide substantial beneficial technical effects, as will be discussed further below. Features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A illustrates a first portion of a workflow for an example system for locating the dependency path(s) of a software vulnerability and automatically repairing the software vulnerability based on the discovered dependency path(s), in accordance with an example embodiment;

FIG. 1B illustrates a second portion of the workflow shown in FIG. 1A, in accordance with an example embodiment;

FIG. 2A is a first portion of a flowchart for an example method for locating the dependency path(s) of software vulnerabilities and automatically repairing software vulnerabilities based on the discovered dependency path(s), in accordance with an example embodiment;

FIG. 2B is a second portion of the flowchart of FIG. 2A, in accordance with an example embodiment;

FIG. 3 is a flowchart for another example method for locating the dependency path(s) of software vulnerabilities and automatically repairing the software vulnerabilities based on the discovered dependency path(s), in accordance with an example embodiment;

FIG. 4 illustrates example constructed Monte Carlo trees created using the expansion function of a Monte Carlo search algorithm, in accordance with example embodiments;

FIG. 5 illustrates an example optimization search to generate a Monte Carlo tree from a Monte Carlo tree using simulation, in accordance with example embodiments;

FIG. 6 illustrates an example optimization search to generate a Monte Carlo tree from a Monte Carlo tree using backpropagation, in accordance with an example embodiment;

FIG. 7A illustrates a first portion of a fusion of different candidate Monte Carlo trees, in accordance with an example embodiment;

FIG. 7B illustrates a second portion of the fusion shown in FIG. 7A, in accordance with an example embodiment; and

FIG. 8 depicts a computing environment according to an embodiment of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

Given the discussion herein (reference characters refer to the drawings discussed below), it will be appreciated that in one aspect, an exemplary method includes constructing a Monte Carlo tree structure 404, 408, 412 of related software packages for a software project 216 (operation 254), wherein one or more vulnerable nodes of the Monte Carlo tree structure 404, 408, 412 indicate a software vulnerability; applying a Monte Carlo tree search algorithm on the Monte Carlo tree structure 404, 408, 412 (operation 258), the applying comprising: expanding the Monte Carlo tree structure 404, 408, 412 with multiple respective candidate nodes corresponding to alternative software packages for replacement of the one or more vulnerable nodes; and performing iterative simulation and backpropagation through different tree updates using the multiple respective candidate nodes to identify at least one best replacement node from the multiple candidate nodes (operations 258-266); and exporting a repaired software set for the software project 216 (operation 270), the repaired software set including additional software corresponding to the at least one identified best replacement node, the additional software replacing one or more software packages that are related to the one or more vulnerable nodes. The technical benefits include the ability to locate the dependency path(s) of software vulnerabilities; automatic identification and repair of software vulnerabilities based on the discovered dependency path(s); automatic provisioning of repair reports; the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In example embodiments, the constructing and applying steps are repeated for the software project 216 using another base software package as a root node for another Monte Carol tree structure 404, 408, 412, wherein the repaired software set that is exported includes a second repaired software set based on the other base software package. The technical benefits include the creation of a variety of Monte Carol tree structures 404, 408, 412 based on a wider range of software packages.

In example embodiments, the constructing of the Monte Carlo tree structure 404, 408, 412 comprises scanning software to obtain reports and scan logs 220, 224 and to determine dependencies of the software packages for the software project 216. The technical benefits include ensuring that the repaired software set meets the dependency requirements of the utilized software components.

In example embodiments, the Monte Carlo tree structure 404, 408, 412 is fused with other candidate Monte Carlo trees 404, 408, 412 based on the best replacement node of the Monte Carlo tree structure 404, 408, 412 (operation 316) and the exporting of the repaired software set is based on the fused Monte Carlo tree structure. The technical benefits include automatic repair of software vulnerabilities based on discovered dependency path(s); the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In example embodiments, the step of applying the Monte Carlo tree search algorithm comprises tracing a source and the replacing of the one or more software packages that are related to the one or more vulnerable nodes occurs prior to the fusing (operation 316) of the Monte Carlo tree structure 404, 408, 412 with the other candidate Monte Carlo trees 404, 408, 412. The technical benefits include replacing the vulnerable nodes of the Monte Carlo trees 404, 408, 412.

In example embodiments, the step of applying the Monte Carlo tree search algorithm comprises constructing a selected function for different nodes for the Monte Carlo tree structure 404, 408, 412, the simulation is performed for different routes of the Monte Carlo tree structure 404, 408, 412, and the selected function is used for performing the backpropagation. The technical benefits include achieving the advantages as discussed above with a convenient way of performing automatic detection of repair suggestions that can avoid software vulnerability risks, and automatically re-scanning and building a revised candidate software package.

In example embodiments, the performing of the simulation for the different routes comprises starting from a root node of the Monte Carlo tree structure 404, 408, 412, selecting one software component for each level of the Monte Carlo tree structure 404, 408, 412 and performing the simulation to end nodes while recording a count of visits for different nodes of the Monte Carlo tree structure 404, 408, 412. The technical benefits include ensuring that the selected repaired software set is optimally selected and performs as intended.

In example embodiments, the constructed selected function for each node is defined as:

$$UCT ( {v}_{p a c {k}_{s a t}} , {v}_{p a c {k}_{explored}} ) = {v}_{p a c {k}_{s a t}} / {v}_{p a c {k}_{explored}} + C * \sqrt{( Log ( {v}_{p a c {k}_{explored}} ) / {v}_{p a c {k}_{s a t}} )}$$

where v_{pack} sat is a satisfaction count of a corresponding software package and v_{pack}_{_{explored}} is a count of visits of the corresponding software package. The technical benefits include achieving the advantages as discussed above with a convenient way of generating a more appropriate software package using the Monte Carlo Tree search algorithm.

In example embodiments, invalid nodes are pruned based on the constructed selected function. The technical benefits include achieving the advantages as discussed above with a convenient way of updating the MCT 274.

In example embodiments, the performing of the iterative simulation and backpropagation to identify the best replacement node further comprises verifying a resulting project file. The technical benefits include ensuring that the resulting project file is operational and meets the specified project requirements.

In example embodiments, the exported repaired software set is tested; the tested repaired software set is deployed; and the deployed repaired software set is run. The technical benefits include the ability to automatically identify and repair software vulnerabilities based on the discovered dependency path(s); automatic provisioning of repair reports; and automatic identification of repair suggestions that can mitigate, for example, software compatibility issues and automatically re-scan and build the package.

In one aspect, a computer program product comprises one or more tangible computer-readable storage media and program instructions stored on at least one of the one or more tangible computer-readable storage media, the program instructions executable by a processor, the program instructions comprising constructing a Monte Carlo tree structure 404, 408, 412 of related software packages for a software project 216 (operation 254), wherein one or more vulnerable nodes of the Monte Carlo tree structure 404, 408, 412 indicate a software vulnerability; applying a Monte Carlo tree search algorithm on the Monte Carlo tree structure 404, 408, 412 (operation 258), the applying comprising: expanding the Monte Carlo tree structure 404, 408, 412 with multiple respective candidate nodes corresponding to alternative software packages for replacement of the one or more vulnerable nodes; and performing iterative simulation and backpropagation through different tree updates using the multiple respective candidate nodes to identify at least one best replacement node from the multiple candidate nodes (operations 258-266); and exporting a repaired software set for the software project 216 (operation 270), the repaired software set including additional software corresponding to the at least one identified best replacement node, the additional software replacing one or more software packages that are related to the one or more vulnerable nodes. The technical benefits include the ability to locate the dependency path(s) of software vulnerabilities; automatic identification and repair of software vulnerabilities based on the discovered dependency path(s); automatic provisioning of repair reports; the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In one aspect, a system comprises a memory and at least one processor, coupled to the memory, and operative to perform operations comprising constructing a Monte Carlo tree structure 404, 408, 412 of related software packages for a software project 216 (operation 254), wherein one or more vulnerable nodes of the Monte Carlo tree structure 404, 408, 412 indicate a software vulnerability; applying a Monte Carlo tree search algorithm on the Monte Carlo tree structure 404, 408, 412 (operation 258), the applying comprising: expanding the Monte Carlo tree structure 404, 408, 412 with multiple respective candidate nodes corresponding to alternative software packages for replacement of the one or more vulnerable nodes; and performing iterative simulation and backpropagation through different tree updates using the multiple respective candidate nodes to identify at least one best replacement node from the multiple candidate nodes (operations 258-266); and exporting a repaired software set for the software project 216 (operation 270), the repaired software set including additional software corresponding to the at least one identified best replacement node, the additional software replacing one or more software packages that are related to the one or more vulnerable nodes. The technical benefits include the ability to locate the dependency path(s) of software vulnerabilities; automatic identification and repair of software vulnerabilities based on the discovered dependency path(s); automatic provisioning of repair reports; the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In one aspect, the operations of scanning software 216 to obtain reports and scan logs 220, 224 (operation 250); constructing an initial Monte Carlo tree structure 274 of related software packages of the software 216 based on the reports and scan logs 220, 224 (operation 254); iteratively updating the initial Monte Carlo tree structure 274 using a Monte Carlo tree search algorithm based on backpropagation (operation 258); searching for a best node in the updated Monte Carlo tree structure to mitigate a software vulnerability (operation 262); and generating a repaired software package based on the updated Monte Carlo tree structure (operation 270). The technical benefits include the ability to locate the dependency path(s) of software vulnerabilities; automatic identification and repair of software vulnerabilities based on the discovered dependency path(s); automatic provisioning of repair reports; the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In one example embodiment, the updated Monte Carlo tree structure is fused with other candidate Monte Carlo trees based on the best node of the updated Monte Carlo tree structure and the generating the repaired software package is based on the fused Monte Carlo tree structure. The technical benefits include automatic repair of software vulnerabilities based on discovered dependency path(s); the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In one example embodiment, the constructing of the initial Monte Carlo tree structure 274 is based on security vulnerabilities. The technical benefits include achieving the advantages as discussed above with a convenient way of generating a more appropriate software package (according to an optimal weight path) using the Monte Carlo Tree search algorithm, combined with the idea of backpropagation in deep learning, through optimizing weight coefficients of tree nodes.

Security vulnerabilities can refer to issues that are found through scanning the major software project, and/or can be from basic packages.

In one example embodiment, the iteratively updating the revised Monte Carlo tree structure 274 further comprises tracing a source, analyzing one or more most suitable repair nodes and automatically attempting to repair or replace a software component prior to the fusing of the updated Monte Carlo tree structure with the other candidate Monte Carlo trees. The technical benefits include achieving the advantages as discussed above with a convenient way of performing automatic detection of repair suggestions that can avoid software vulnerability risks, and automatically re-scanning and building a revised candidate software package.

In one example embodiment, the constructing of the initial Monte Carlo tree structure 274 further comprises performing expansion for a current version of a given level package. The technical benefits include achieving the advantages as discussed above with a convenient way of generating a more appropriate software package using the Monte Carlo Tree search algorithm.

In one example embodiment, the iterative updating of the initial Monte Carlo tree structure 274 further comprises constructing a selected function for different nodes for the initial Monte Carlo tree structure 274, performing a simulation for different routes of the initial Monte Carlo tree structure 274 and using the defined selected function for backpropagation. The technical benefits include achieving the advantages as discussed above with a convenient way of performing automatic detection of repair suggestions that can avoid software vulnerability risks, and automatically re-scanning and building a revised candidate software package.

In one example embodiment, the performing the simulation for the different routes further comprises, starting from a root node, selecting one software component for each level and performing the simulation to end nodes while recording a count of visits for different nodes of the initial Monte Carlo tree structure 274. The technical benefits include achieving the advantages as discussed above with a convenient way of generating a more appropriate software package using the Monte Carlo Tree search algorithm, combined with the idea of backpropagation in deep learning, through optimizing weight coefficients of tree nodes.

In one example embodiment, the constructed selected function for each node is defined as:

$$UCT ( {v}_{p a c {k}_{sat}} , {v}_{p a c {k}_{explored}} ) = {v}_{p a c {k}_{s a t}} / {v}_{p a c {k}_{explored}} + C * \sqrt{( Log ( {v}_{p a c {k}_{explored}} ) / {v}_{{pack}_{sat}} )}$$

where v_{pack}_{ₛₐₜ} is a satisfaction count of a corresponding software package and v_{pack}_{_{explored}} is a count of visits of the corresponding software package. The technical benefits include achieving the advantages as discussed above with a convenient way of generating a more appropriate software package using the Monte Carlo Tree search algorithm.

In one example embodiment, invalid nodes are pruned based on the constructed selected function. The technical benefits include achieving the advantages as discussed above with a convenient way of updating the MCT 274.

In one example embodiment, the searching for the best node further comprises verifying a resulting project file. The technical benefits include achieving the advantages as discussed above with a convenient way of performing automatic detection of repair suggestions that can avoid software vulnerability risks, and building a revised functional candidate software package.

In one example embodiment, the repaired software package is tested, the repaired software package is deployed and the deployed repaired software package is run. The technical benefits include the ability to automatically identify and repair software vulnerabilities based on the discovered dependency path(s); automatic provisioning of repair reports; and automatic identification of repair suggestions that can mitigate, for example, software compatibility issues and automatically re-scan and build the package.

In one aspect, a computer program product comprises one or more tangible computer-readable storage media and program instructions stored on at least one of the one or more tangible computer-readable storage media, the program instructions executable by a processor, the program instructions comprising scanning software 216 to obtain reports and scan logs 220, 224 (operation 250); constructing an initial Monte Carlo tree structure 274 of related software packages of the software 216 based on the reports and scan logs 220, 224 (operation 254); iteratively updating the initial Monte Carlo tree structure 274 using a Monte Carlo tree search algorithm based on backpropagation (operation 258); searching for a best node in the updated Monte Carlo tree structure to mitigate a software vulnerability (operation 262); and generating a repaired software package based on the updated Monte Carlo tree structure (operation 270). The technical benefits include the ability to locate the dependency path(s) of software vulnerabilities; automatic identification and repair of software vulnerabilities based on the discovered dependency path(s); automatic provisioning of repair reports; the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

In one aspect, a system comprises a memory and at least one processor, coupled to the memory, and operative to perform operations comprising scanning software 216 to obtain reports and scan logs 220, 224 (operation 250); constructing an initial Monte Carlo tree structure 274 of related software packages of the software 216 based on the reports and scan logs 220, 224 (operation 254); iteratively updating the initial Monte Carlo tree structure 274 using a Monte Carlo tree search algorithm based on backpropagation (operation 258); searching for a best node in the updated Monte Carlo tree structure to mitigate a software vulnerability (operation 262); and generating a repaired software package based on the updated Monte Carlo tree structure (operation 270). The technical benefits include methods and techniques for locating the dependency path(s) of software vulnerabilities; automatic identification and repair of software vulnerabilities based on the discovered dependency path(s); automatic provision of repair reports; more appropriate software package (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package. The technical benefits include the ability to locate the dependency path(s) of software vulnerabilities; automatic identification and repair of software vulnerabilities based on the discovered dependency path(s); automatic provisioning of repair reports; the generation of more appropriate software packages (according to an optimal weight path) generated using a Monte Carlo Tree search algorithm, combined with the idea of backpropagation in deep learning, through optimizing weight coefficients of tree nodes; and automatic identification of repair suggestions that can mitigate, for example, software compatibility issues and automatically re-scan and build the package.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
techniques for locating the dependency path(s) of software vulnerabilities;
automatic identification and repair of software vulnerabilities based on the discovered dependency path(s);
automatic provision of repair reports;
automatic detection of repair suggestions that can avoid software vulnerability risks, and automatically re-scan and build a revised candidate software package;
more appropriate software package (according to an optimal weight path) generated using a Monte Carlo Tree search algorithm, combined with the idea of backpropagation in deep learning, through optimizing weight coefficients of tree nodes;
automatic identification of repair suggestions that can mitigate, for example, software compatibility issues and automatically re-scan and build the package;
acceleration of development and operations (DevOps) processes, making automatic deployment more effective and improving the overall efficiency of the DevOps teams; and
techniques to accelerate the development/operations (DevOps) process, make automatic deployment more effective, and improve the overall efficiency of software development teams.

During the development of software projects, a variety of software development issues need to be monitored and addressed. For example, conflicts between multiple versions of software components in a software package (such as multiple base Java® archive (“JAR”) package versions that coexist in the final Java® project release and that result in unnecessary package size increases); package compatibility issues after implementation of a software repair; replacement of a software package (for example, replacing a first conventional machine learning framework that is unusable due to given project constraints with a second conventional machine learning framework) and the like.

In one example embodiment, to address these issues, a tree structure is built by analyzing the dependency relationships between software components. A backpropagation algorithm of neural networks is combined with a Monte Carlo Tree (MCT) search algorithm, so that the node route of the Monte Carlo search tree that was built is updated using backpropagation and corresponding updated weights. (A Monte Carlo search tree expands a search tree using a random sampling of a search space.) In one example embodiment, reinforcement learning is used as a basic framework to perform the dynamic updating of the weights. The generated tree structure helps developers locate the dependency path(s) of software vulnerabilities, automatically detect defects and repair software problems according to the dependency path(s) and provide related repair reports. It is worth noting that in one or more embodiments, given the teachings herein, the skilled artisan can adapt known reinforcement learning techniques to accelerate optimization efficiency.

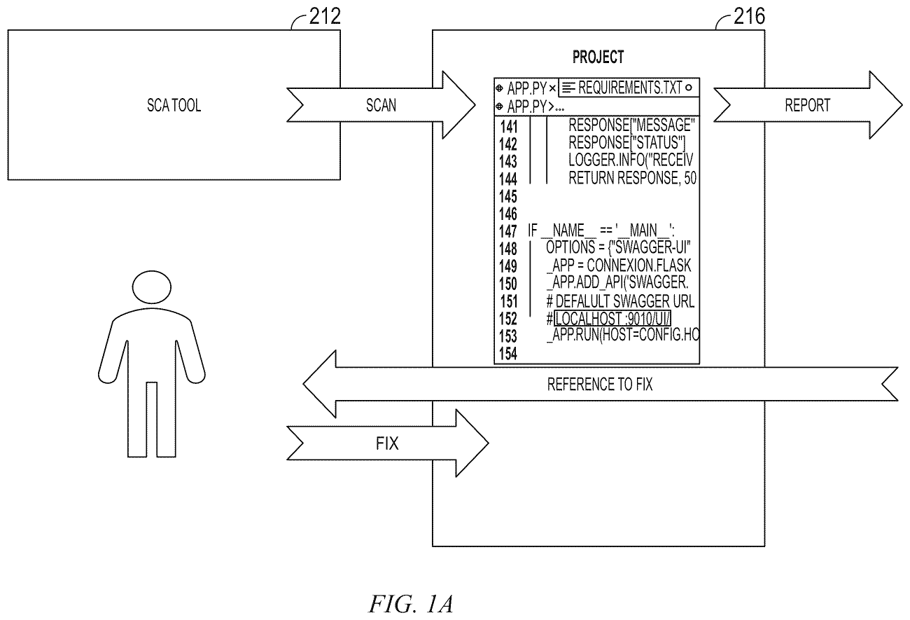

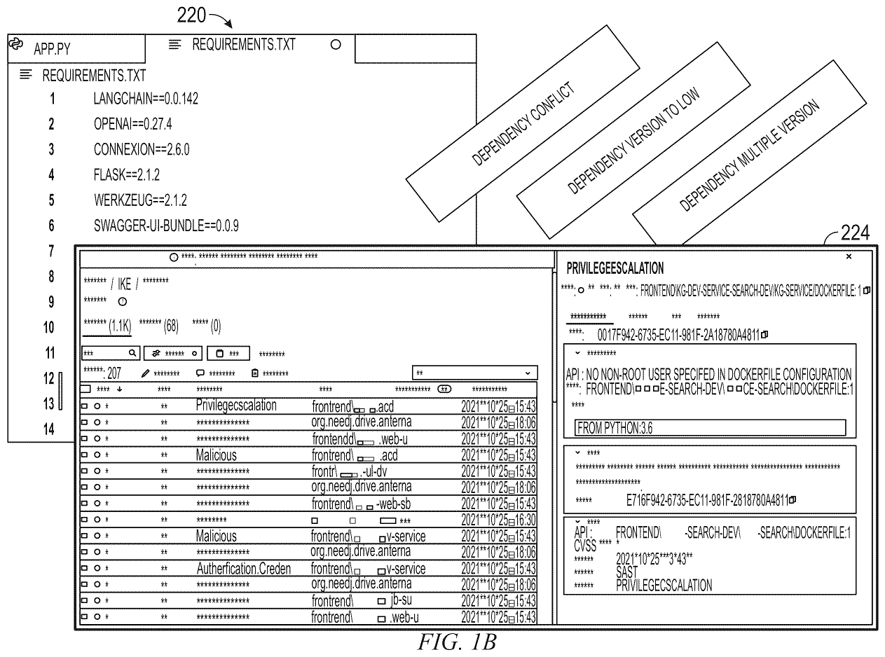

FIGS. 1A-1B illustrate a workflow for an example system for locating the dependency path(s) of a software vulnerability and automatically repairing the software vulnerability based on the discovered dependency path(s), in accordance with an example embodiment. Software composition analysis (SCA) tools 212 scan a software project 216, including the individual software components of the software project 216. A dependency tree is generated based on the scan, and, as shown in FIG. 1B, reports 224 are produced, such as requirements report 220 (requirements.txt) and repair suggestions. The workflow includes identifying dependency conflicts, dependent versions of components that do not meet the project requirements (e.g., low package version 0.1), dependent versions of components that meet the project requirements, and/or dependent components that have multiple versions that meet the project requirements (e.g., mainstream versions 1.1 and 1.2).

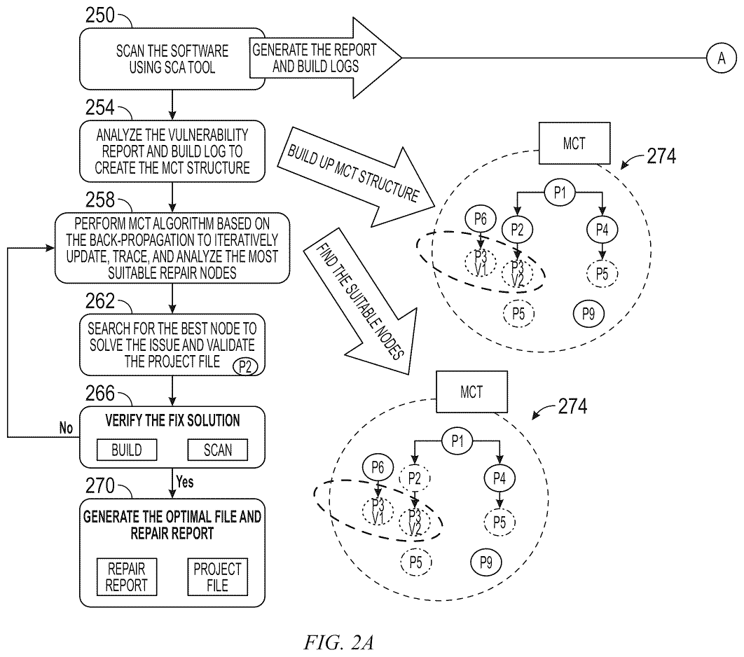

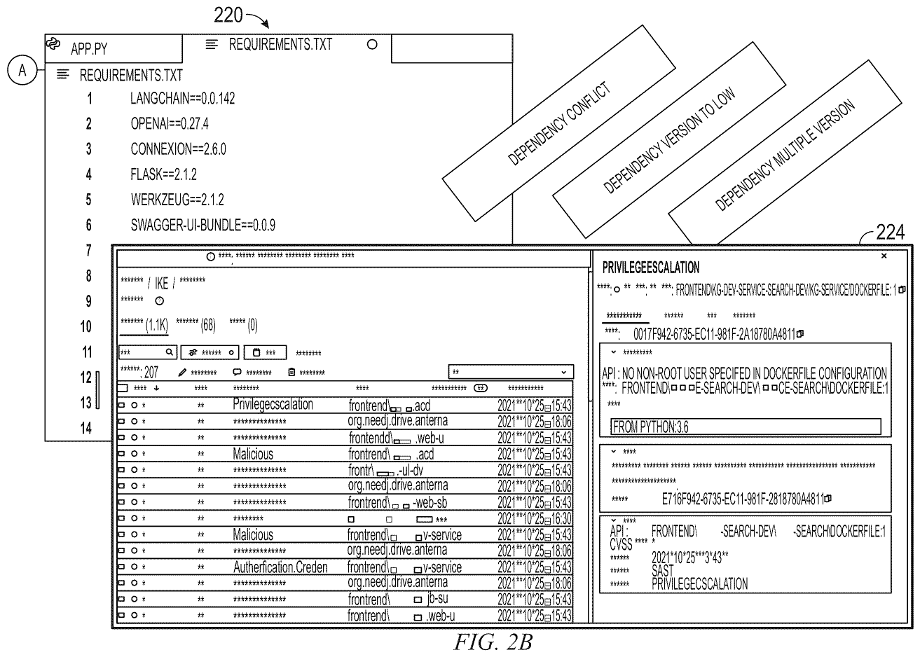

FIGS. 2A and 2B are a flowchart for an example method for locating the dependency path(s) of software vulnerabilities and automatically repairing software vulnerabilities based on the discovered dependency path(s), in accordance with an example embodiment. In one example embodiment, software is scanned using SCA tools 212 to obtain vulnerability reports and scan logs that are part of the reports 220, 224 (operation 250). The dependencies of the packages of the software project 216 are analyzed based on the vulnerability reports and the scan (build) logs that are part of the reports 220, 224, and an initial Monte Carlo tree structure 274 of related software packages is constructed based on, for example, the security vulnerabilities (operation 254). For example, the basic package, such as Pandas (generally, an open-source software library for working with data and a non-limiting example), can be used as a root node of the MCT 274. Expansion for the current version of this level package, like NumPy 1.1 or NumPy 1.2, is performed. For each level, the same package can be utilized with a different version (such as NumPy 1.1 or NumPy 1.2), or the same function packages, such as the same version of NumPy (generally, a software library that facilitates efficient numerical operations on large quantities of data and a non-limiting example), can be utilized.

It is worth noting that in one or more embodiments, performing expansion for the MCT search algorithm refers to identifying possible software packages that could remedy a vulnerable piece of software by replacing the vulnerable software component. The expansion in some embodiments includes comparing textually described requirements for a software component with textual descriptions of other known software components. These textual descriptions of other known software components are stored in a local data library and/or accessed in an online search. Thus, natural language processing (NLP), e.g., with semantic comparison that may invoke cosine similarity, is involved in some initial matching to find possible replacement software that could help fulfill the requirements of an overall software project.

In the case of the same function packages, it is noted that selecting packages with similar functionalities (such as two packages that can achieve the same functions for the project) is aimed at increasing the options available for later stages of the process. By performing the expansion with the use of packages that have similar functionalities for, for example, NumPy, more candidates for package selection and replacement are provided for future steps of the tree building process.

Furthermore, a given software project refers to software developed by a developer to meet requirements of an enterprise, while basic packages or dependency packages are packages used by the developer to develop the overall software project.

Iterative updates to the Monte Carlo tree structure 274 are then generated using an MCT search algorithm. The performance of the MCT search algorithm includes one or more of backpropagation, tracing the source (that is, tracing a conflicting package version (associated with the link/edge of the MCT 274) that is considered to be an incorrect package according to project requirements), analyzing the nodes that are most suitable to repair (that is, the nodes that meet the project requirements and that score the highest using the evaluation function, as described more fully below) and automatically attempting fixes or replacements in files, such as the requirements.txt file (operation 258).

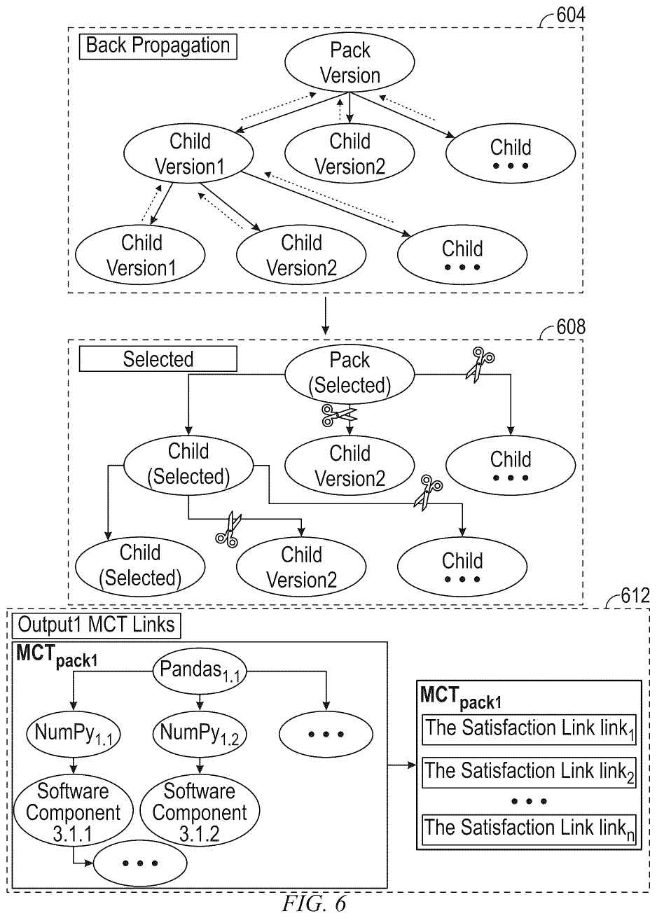

In one example embodiment, the MCT search algorithm based on backpropagation includes:
Step 1—Expansion: the basic package, such as Pandas, is used as the root node of the MCT 274. Expansion is performed for the current version of this level package, such as NumPy 1.1, NumPy 1.2 and the like. For each level, the same package is utilized with a different version (such as NumPy 1.1 or NumPy 1.2), or the same function packages, such as the same version of NumPy, are utilized. In example embodiments, the software packages and components that were identified from the scan information as being vulnerable are used as a starting point and then candidates for replacing these vulnerable software components are identified as part of performing the expansion. The software packages and components may be identified using natural language processing by comparing the project requirements with text-based descriptions of the software packages and components. This step is iterated to construct the entire MCT tree 274, e.g., to finish the MCT tree 274 that was started in operation 254. It is worth noting that in some embodiments, information regarding software packages can be obtained from the Internet or other publicly available sources, and this information can be used by aspects of the invention to identify packages that can meet project requirements. The packages P3V1 and P3V2 enclosed in the oblong dashed line represent different versions of the same package and are generally indicative of a software issue that can be addressed using the MCT.
Step 2—Simulation: simulation is performed for different routes from the root node to a given end node. From the root node, one software component is selected for each level, and a simulation is performed for different sets of links/edges to the end nodes while recording a count of visits to each of the different nodes.
Step 3—Backpropagation: based on the simulation of the route from the root node to a given end node, backpropagation is used to update a satisfaction count (a count of the number of times that the project requirements are satisfied) for each node, using an evaluation function (see, for example, the UCT (Upper Confidence Bound 1 applied to trees) evaluation function described below in conjunction with FIG. 6). For example, if the project requires a version greater than 1.1, the satisfaction count is incremented by 1 if the version is greater than 1.1; otherwise, the satisfaction count is not incremented.
Step 4—Selected: Based on the backpropagation and the evaluation function, the score for each node is computed. The invalid nodes are pruned based on the score for each node. The satisfied links/edges for each different root node are then output (which includes the links/edges from the root node to a leaf node). Furthermore in this regard, “satisfied link(s)” refer to path(s) from the root node to the final leaf nodes of an MCT that meet the project requirements and represent satisfactory solutions. A search for the best node is performed to address the software vulnerability and the resulting project file is verified/validated (operation 262). For example, there are typically many nodes in the MCT 274. In response to the evaluation of satisfaction counts, an evaluation function, as described more fully below, is used to assess the number of times the project requirements are met. Some nodes, however, may have a satisfaction count of 1, while others may have a satisfaction count of 2, and still others may have a satisfaction count of 3. In one example embodiment, the node with the highest satisfaction count is selected as the best node. In instances when two candidate replacement nodes have an equal score in the simulation of the Monte Carlo search algorithm, e.g., an equal satisfaction count, an additional evaluation function is applied. The evaluation function is customizable based on adjusting weights according to needs and preferences for various software components.

A test is then performed to determine if the software problem has been corrected via a new construction (build) and scan (decision block 266). If the problem is not corrected (NO branch of decision block 266), the method loops backward to operation 258 for a repeat of operations 258, 262, and 266; otherwise (YES branch of decision block 266), the optimal file (such as requirements.txt) is generated and exported, and a repair report for the reference of developers and the like is created (operation 270).

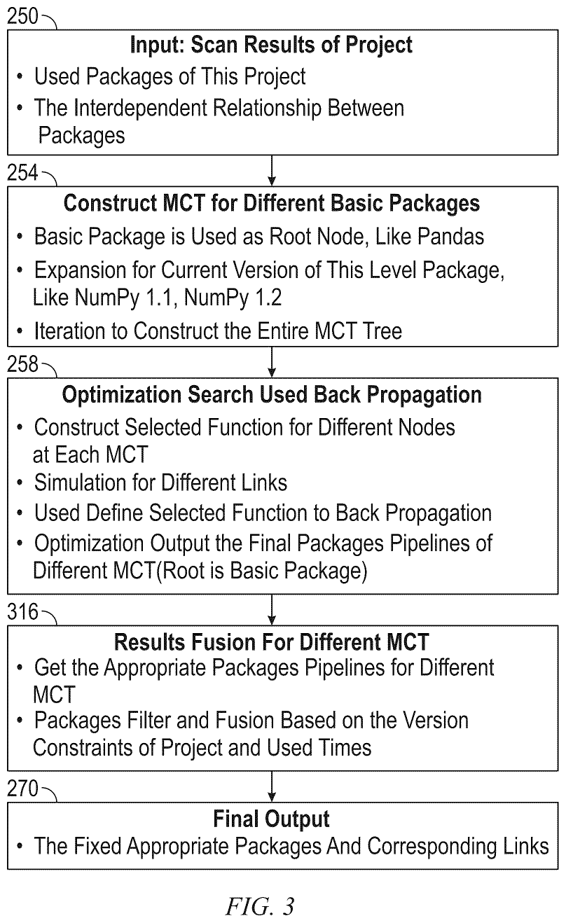

FIG. 3 is a flowchart for another example method for locating the dependency path(s) of software vulnerabilities and automatically repairing the software vulnerabilities based on the discovered dependency path(s), in accordance with an example embodiment. As described above, a software project 216 is scanned using SCA tools 212 to identify the software packages that are used and the interdependent relationships between the software packages and related software components (operation 250). In one example embodiment, the scan logs, e.g., from the reports 220, 224, are analyzed.

An initial Monte Carlo tree structure 274 is constructed for different software packages using a Monte Carlo search algorithm based on, for example, a variety of security vulnerabilities (operation 254). (The basic package of the software project 216 is used as the root node of each MCT 274.) Expansion is performed for the current version of the given level package, such as NumPy 1.1, NumPy 1.2 and the like. The Monte Carlo search algorithm is iterated through to construct an entire Monte Carlo tree 274. This tree construction is based on the Monte Carlo Tree search algorithm, combined with backpropagation in deep learning, through optimizing the weight coefficient of tree nodes. An optimization search is performed using backpropagation (operation 258). A selected function is constructed for different nodes for each MCT 274. A simulation is performed for different links/edges of a corresponding MC tree 274 and the selected function is used for backpropagation. The simulation is performed for different routes from the root node to a given end node. From the root node, one software component is selected for each level, a simulation is performed for different sets of links/edges to the end nodes while recording a count of visits for the different nodes. Moreover, the selection is based on the backpropagation and the UCT (Upper Confidence Bound 1 applied to trees) evaluation function (see FIG. 6) to compute the score for each node. The invalid nodes are pruned based on the score for each node. The satisfied route(s) from the root node to a given end node for each different root node are then output. The output of the optimization is the route(s) from the root node to a given end node of the final software package(s) corresponding to different Monte Carlo trees 274 where the root of each MCT 274 is the basic package of the software project 216.

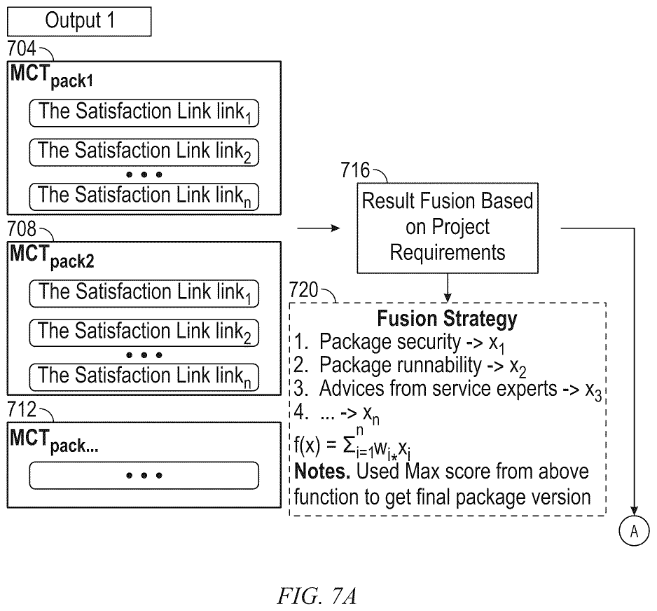

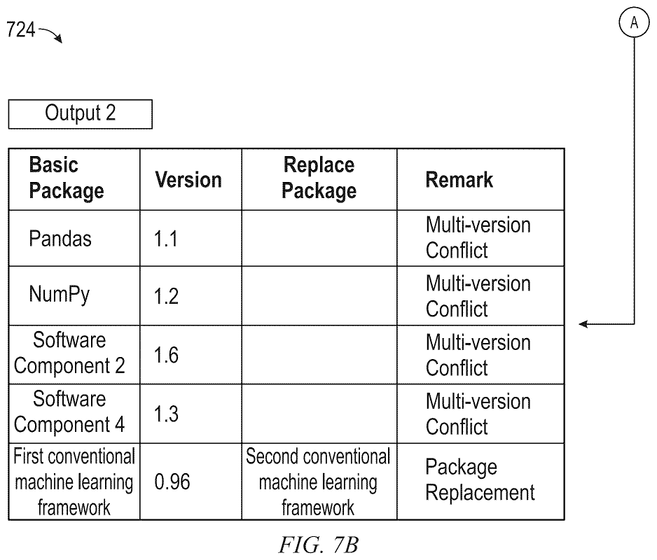

A fusion of the different candidate Monte Carlo trees is performed (operation 316), as described more fully in conjunction with FIGS. 7A and 7B. The repaired software packages and corresponding links/edges are generated as the final output (operation 270); that is, the final output is a more appropriate software package according to the optimal weight path of the MCT 274.

### Construction of Different Monte Carlo Trees

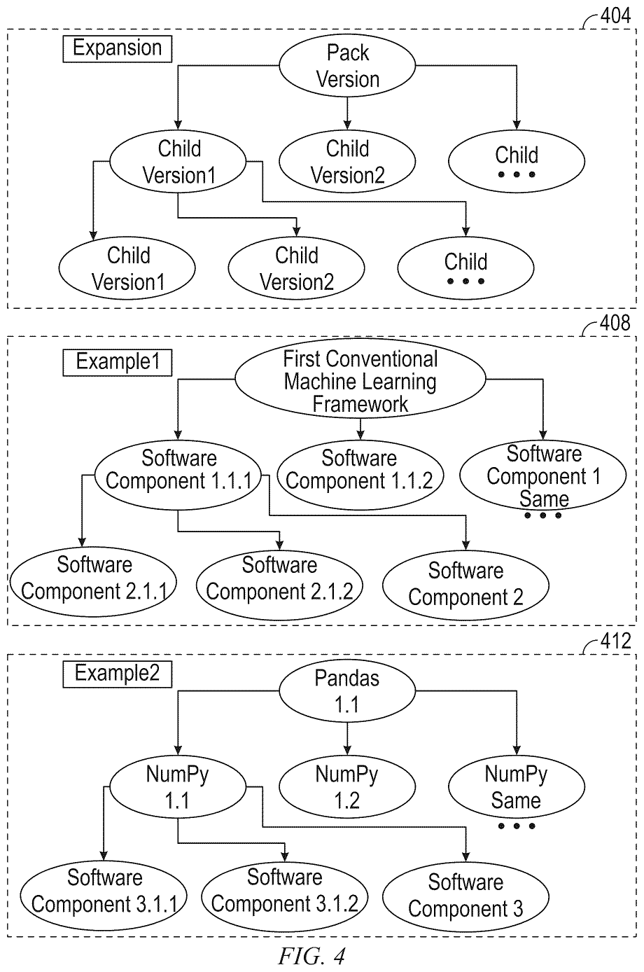

FIG. 4 illustrates example constructed Monte Carlo trees 404, 408, 412 created using the expansion function of a Monte Carlo search algorithm, in accordance with example embodiments. In one example embodiment, a base version of the MCT 404 is generated. Prior to expansion, the Monte Carlo tree 404 consists of only the root node (“Pack [age] Version”). It is noted that the Monte Carlo trees of FIGS. 4-6 are simplified examples and that more complex Monte Carlo trees are contemplated. Different child-level nodes that are connected to and one step away from the base node represent various child versions of the base version. Different second-level nodes that are connected to and one outward step away from the child-level nodes are grand-child nodes to the base node and each represent a different modified version of a child node. For MCT 408, a basic package, such as the first conventional machine learning framework (shown as CMLF 1.1), was used as the root node. In the example of FIG. 4, expansion for a current version of the illustrated level package, like NumPy 1.1, NumPy 1.2, is performed, starting from a Pandas 1.1 package, to generate MCT 412. In example embodiments, expansion is performed for nodes identified as having a security vulnerability and continues until related dependencies are no longer found. For each level of the MCT, the same package with a different version is utilized (it is also possible to use a similar package that has the same functions; for example, both Matplotlib and Echart of the Python package have drawing functions); each level can also have the same function packages, such as the same version of NumPy and NumPy. Iterations of the Monte Carlo search algorithm are then performed to construct the entire Monte Carlo tree 274. In the examples of FIG. 4, the first conventional machine learning framework is the basic package (root node) of MCT 408 while Python (e.g., Pandas 1.1) is the basic package (root node) of MCT 412.

### Optimization Search Using Backpropagation—Part 1

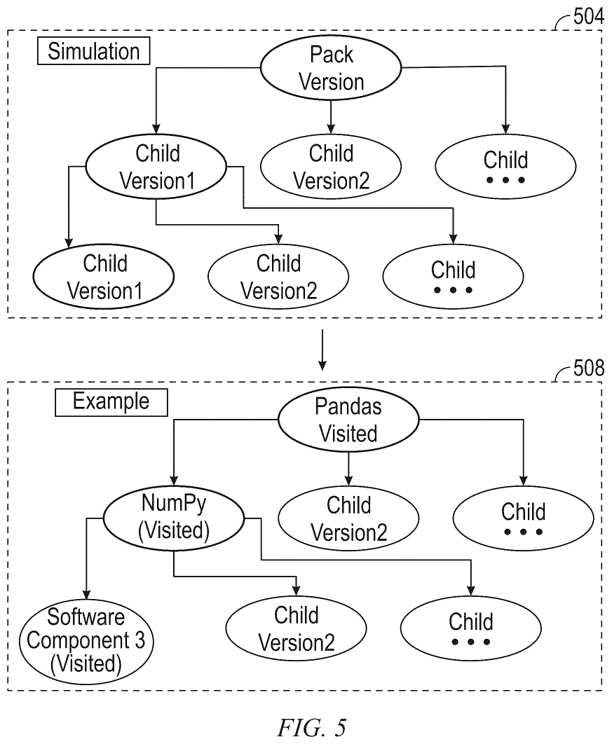

FIG. 5 illustrates an example optimization search to generate a Monte Carlo tree 508 from a MCT 504 using simulation, in accordance with example embodiments. A simulation for different routes from the root node to a given end node is performed to generate the MCT 508. Starting from the root node, one software component is selected for one link of the MCT 508, the simulation for different routes from the root node to a given end node is performed to the end nodes while recording a count of visits for the different nodes. MCT 508 illustrates different nodes within the MCT 508 have been visited via the simulation.

### Optimization Search Using Backpropagation—Part 2

FIG. 6 illustrates an example optimization search to generate a Monte Carlo tree 608 from a MCT 604 using backpropagation, in accordance with an example embodiment. Based on the simulation of the route from the root node to a given end node, backpropagation is used to update the satisfaction count for each node. An evaluation function for each node is defined, such as the UCT evaluation function:

$$UCT ( {v}_{p a c {k}_{sat} ,} {v}_{p a c {k}_{explored}} ) = {v}_{p a c {k}_{s a t}} / {v}_{p a c {k}_{explored}} + C * \sqrt{( Log ( {v}_{p a c {k}_{explored}} ) / {v}_{{pack}_{sat}} )}$$

where v_{pack}_{ₛₐₜ} is the satisfaction count of this package, such as a satisfaction count of 100 for NumPy 1.1; and v_{pack}_{_{explored}} is the count of visits of this package (based on the simulation), such as a visit count of 170 for NumPy 1.1. The score for each node is computed based on the backpropagation and the evaluation function. The invalid nodes are pruned (as indicated by the depicted scissors cutting nodes in the MCT tree 608 in FIG. 6) based on the score for each node resulting from the UCT evaluation function (where the threshold for pruning is based on run details). In one example embodiment, the threshold for pruning is 0.7 and nodes having an UCT evaluation function score of less than 0.7 are pruned from the MCT tree 608. It is noted that, prior to fusion, valid packages are selected based on the software requirements and can thus have different versions of the same program; after fusion, the package will utilize the best version of the program. It is worth noting that one tree will typically include multiple satisfaction links.

### Results Fusion for Different MCTs

FIGS. 7A and 7B illustrate a fusion of different candidate Monte Carlo trees, in accordance with an example embodiment. As described in operations 258 of FIG. 2A and 316 of FIG. 3, a plurality of different Monte Carlo tree candidates 704, 708, 712 are generated by utilizing different software components as the root of the initial MCT (see FIG. 4). The different Monte Carlo tree candidates 704, 708, 712 are then fused together. Starting from the root package for each Monte Carlo tree candidate 704, 708, 712, a route from the root node to a given end node that meets the project requirements may be found for each of the MCT candidates 704, 708, 712 (if a plurality of routes from the root node to a given end node are found for a particular MCT candidate 704, 708, 712, the top link(s) (e.g., the link(s) having the highest score(s) using the valuation function) that satisfy the project requirements can be selected). Results fusion 716, 720 is performed based on project requirements, such as whether certain packages can be used, package version requirements, package version compatibility and/or the like, to generate a result 724 for each candidate package. In one example embodiment, a function

$$f ( x ) = {\sum }_{i = 1}^{n} {w}_{i} * {x}_{i}$$

is evaluated, where, for example, x₁ represents package security, x₂ represents package runnability, x₃ represents advice from service experts and wᵢ represents a corresponding weight. The maximum score from the above function is used to identify the final package version.

Finally, based on the backpropagation up the branches of the candidate MCT 704, 708, 712 through optimization of the weight coefficients of nodes of the MC trees, the dependency relationship with the largest weight coefficient is identified as the recommended dependency package. It is noted that various error types may be encountered during the fusion process of FIGS. 7A-7B. Multi-version conflict refers to the situation where multiple versions of a package are used in a project. During the project build phase, it is appropriate to unify these versions into a single usable package that meets the project requirements. A package replacement error means that a package chosen at the beginning of the project, such as the first conventional machine learning framework, may no longer meet the requirements of a given project due to changes in the project scope. Consequently, the original package (e.g., the first conventional machine learning framework) needs to be replaced with an alternative package that serves the same function, such as a second conventional machine learning framework.

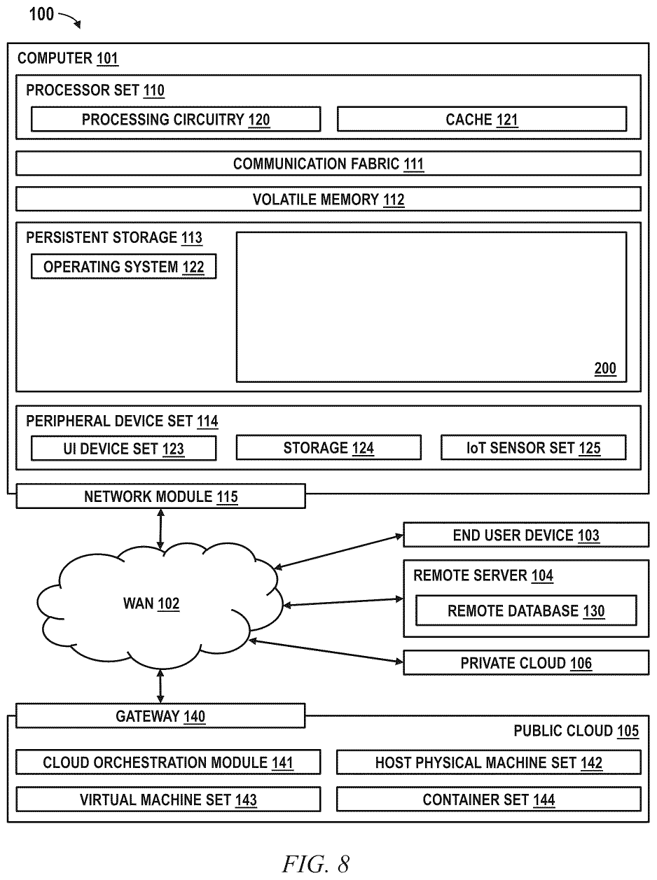

### Refer Now to FIG. 8.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code optimization system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 8. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
constructing a Monte Carlo tree structure of related software packages for a software project, wherein one or more vulnerable nodes of the Monte Carlo tree structure indicate a software vulnerability;
applying a Monte Carlo tree search algorithm on the Monte Carlo tree structure, the applying comprising:
expanding the Monte Carlo tree structure with multiple respective candidate nodes corresponding to alternative software packages for replacement of the one or more vulnerable nodes; and
performing iterative simulation and backpropagation through different tree updates using the multiple respective candidate nodes to identify at least one best replacement node from the multiple candidate nodes; and
exporting a repaired software set for the software project, the repaired software set including additional software corresponding to the at least one identified best replacement node, the additional software replacing one or more software packages that are related to the one or more vulnerable nodes.

2. The computer-implemented method of claim 1, further comprising repeating the constructing and applying steps for the software project using another base software package as a root node for another Monte Carol tree structure, wherein the repaired software set that is exported includes a second repaired software set based on the other base software package.

3. The computer-implemented method of claim 1, wherein the constructing of the Monte Carlo tree structure comprises scanning software to obtain reports and scan logs and to determine dependencies of the software packages for the software project.

4. The computer-implemented method of claim 1, further comprising fusing the Monte Carlo tree structure with other candidate Monte Carlo trees based on the best replacement node of the Monte Carlo tree structure and wherein the exporting of the repaired software set is based on the fused Monte Carlo tree structure.

5. The computer-implemented method of claim 4, wherein the step of applying the Monte Carlo tree search algorithm comprises tracing a source and wherein the replacing of the one or more software packages that are related to the one or more vulnerable nodes occurs prior to the fusing of the Monte Carlo tree structure with the other candidate Monte Carlo trees.

6. The computer-implemented method of claim 1, wherein the step of applying the Monte Carlo tree search algorithm comprises constructing a selected function for different nodes for the Monte Carlo tree structure, wherein the simulation is performed for different routes of the Monte Carlo tree structure, and wherein the selected function is used for performing the backpropagation.

7. The computer-implemented method of claim 6, wherein the performing of the simulation for the different routes comprises, starting from a root node of the Monte Carlo tree structure, selecting one software component for each level of the Monte Carlo tree structure and performing the simulation to end nodes while recording a count of visits for different nodes of the Monte Carlo tree structure.

8. The computer-implemented method of claim 6, wherein the constructed selected function for each node is defined as:
$$UCT ( {v}_{p a c {k}_{sat}} , {v}_{p a c {k}_{explored}} ) = {v}_{p a c {k}_{s a t}} / {v}_{p a c {k}_{explored}} + C * \sqrt{( Log ( {v}_{p a c {k}_{explored}} ) / {v}_{{pack}_{sat}} )}$$
where v_{pack}_{ₛₐₜ} is a satisfaction count of a corresponding software package and v_{pack}_{_{explored}} is a count of visits of the corresponding software package.

9. The computer-implemented method of claim 8, further comprising pruning invalid nodes based on the constructed selected function.

10. The computer-implemented method of claim 1, wherein the performing of the iterative simulation and backpropagation to identify the best replacement node further comprises verifying a resulting project file.

11. The computer-implemented method of claim 1, further comprising:
testing the exported repaired software set;
deploying the tested repaired software set; and
running the deployed repaired software set.

12. A computer program product, comprising:
one or more tangible computer-readable storage media and program instructions stored on at least one of the one or more tangible computer-readable storage media, the program instructions executable by a processor, the program instructions comprising:
constructing a Monte Carlo tree structure of related software packages for a software project, wherein one or more vulnerable nodes of the Monte Carlo tree structure indicate a software vulnerability;
applying a Monte Carlo tree search algorithm on the Monte Carlo tree structure, the applying comprising:
expanding the Monte Carlo tree structure with multiple respective candidate nodes corresponding to alternative software packages for replacement of the one or more vulnerable nodes; and
performing iterative simulation and backpropagation through different tree updates using the multiple respective candidate nodes to identify at least one best replacement node from the multiple candidate nodes; and
exporting a repaired software set for the software project, the repaired software set including additional software corresponding to the at least one identified best replacement node, the additional software replacing one or more software packages that are related to the one or more vulnerable nodes.

13. A system comprising:
a memory; and
at least one processor, coupled to the memory, and operative to perform operations comprising:
constructing a Monte Carlo tree structure of related software packages for a software project, wherein one or more vulnerable nodes of the Monte Carlo tree structure indicate a software vulnerability;
applying a Monte Carlo tree search algorithm on the Monte Carlo tree structure, the applying comprising:
expanding the Monte Carlo tree structure with multiple respective candidate nodes corresponding to alternative software packages for replacement of the one or more vulnerable nodes; and
performing iterative simulation and backpropagation through different tree updates using the multiple respective candidate nodes to identify at least one best replacement node from the multiple candidate nodes; and
exporting a repaired software set for the software project, the repaired software set including additional software corresponding to the at least one identified best replacement node, the additional software replacing one or more software packages that are related to the one or more vulnerable nodes.

14. The system of claim 13, the operations further comprising repeating the constructing and applying steps for the software project using another base software package as a root node for another Monte Carol tree structure, wherein the repaired software set that is exported includes a second repaired software set based on the other base software package.

15. The system of claim 13, wherein the constructing of the Monte Carlo tree structure comprises scanning software to obtain reports and scan logs and to determine dependencies of the software packages for the software project.

16. The system of claim 13, the operations further comprising fusing the Monte Carlo tree structure with other candidate Monte Carlo trees based on the best replacement node of the Monte Carlo tree structure and wherein the exporting of the repaired software set is based on the fused Monte Carlo tree structure.

17. The system of claim 16, wherein the step of applying the Monte Carlo tree search algorithm comprises tracing a source and wherein the replacing of the one or more software packages that are related to the one or more vulnerable nodes occurs prior to the fusing of the Monte Carlo tree structure with the other candidate Monte Carlo trees.

18. The system of claim 13, wherein the step of applying the Monte Carlo tree search algorithm comprises constructing a selected function for different nodes for the Monte Carlo tree structure, wherein the simulation is performed for different routes of the Monte Carlo tree structure, and wherein the selected function is used for performing the backpropagation.

19. The system of claim 18, wherein the performing of the simulation for the different routes comprises, starting from a root node of the Monte Carlo tree structure, selecting one software component for each level of the Monte Carlo tree structure and performing the simulation to end nodes while recording a count of visits for different nodes of the Monte Carlo tree structure.

20. The system of claim 13, wherein the performing of the iterative simulation and backpropagation to identify the best replacement node further comprises verifying a resulting project file.
